(19) United States
(12) Patent Application Publication
(10) Pub. No.: US 2020/0010056 A1
(43) Pub. Date: Jan. 9, 2020

(54) ICE SCRAPING ASSEMBLY

(71) Applicant: Derek Bates, Alpharetta, GA (US)

(72) Inventor: Derek Bates, Alpharetta, GA (US)

(21) Appl. No.: 16/030,448

(22) Filed: Jul. 9, 2018

(51) Int. Cl. B60S 3/04

(52) U.S. Cl. CPC B60S 3/045

(57) ABSTRACT

An ice scraping assembly for scraping ice from a windshield includes a bowl that has an outer edge. The outer edge tapers to a point for abrading ice from a windshield. The outer edge has a jagged portion comprising a plurality of teeth. The teeth enhance abrading the ice from the windshield. A grip is coupled to the bowl for gripping.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to scraping devices and more particularly pertains to a new scraping device for scraping ice from a windshield.

### BRIEF SUMMARY OF THE INVENTION

An embodiment of the disclosure meets the needs presented above by generally comprising a bowl that has an outer edge. The outer edge tapers to a point for abrading ice from a windshield. The outer edge has a jagged portion comprising a plurality of teeth. The teeth enhance abrading the ice from the windshield. A grip is coupled to the bowl for gripping.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an ice scraping assembly according to an embodiment of the disclosure.

FIG. 2 is a bottom perspective view of an embodiment of the disclosure.

FIG. 3 is a top view of an embodiment of the disclosure.

FIG. 4 is a front view of an embodiment of the disclosure.

FIG. 5 is a perspective in-use view of an embodiment of the disclosure.

### DETAILED DESCRIPTION OF THE INVENTION

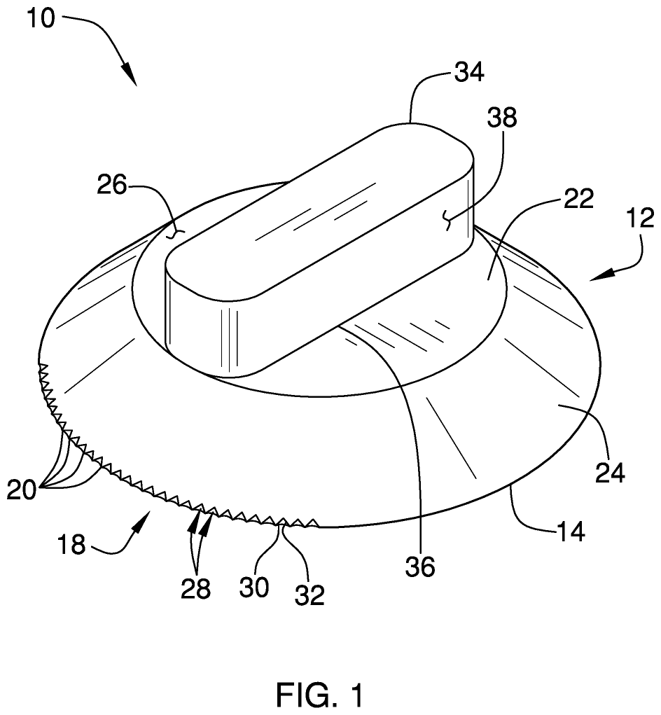

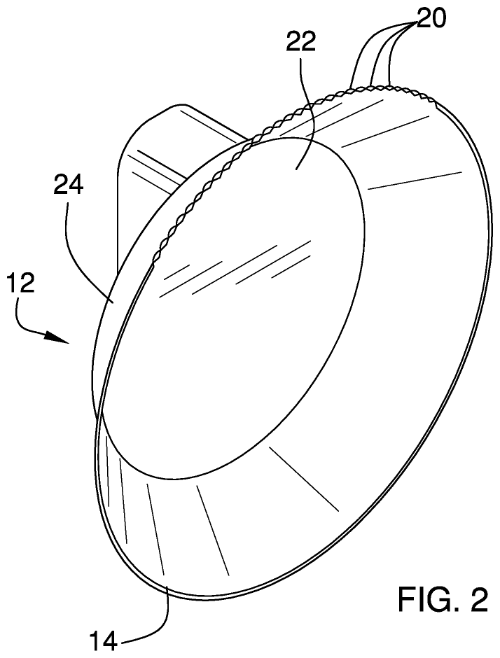

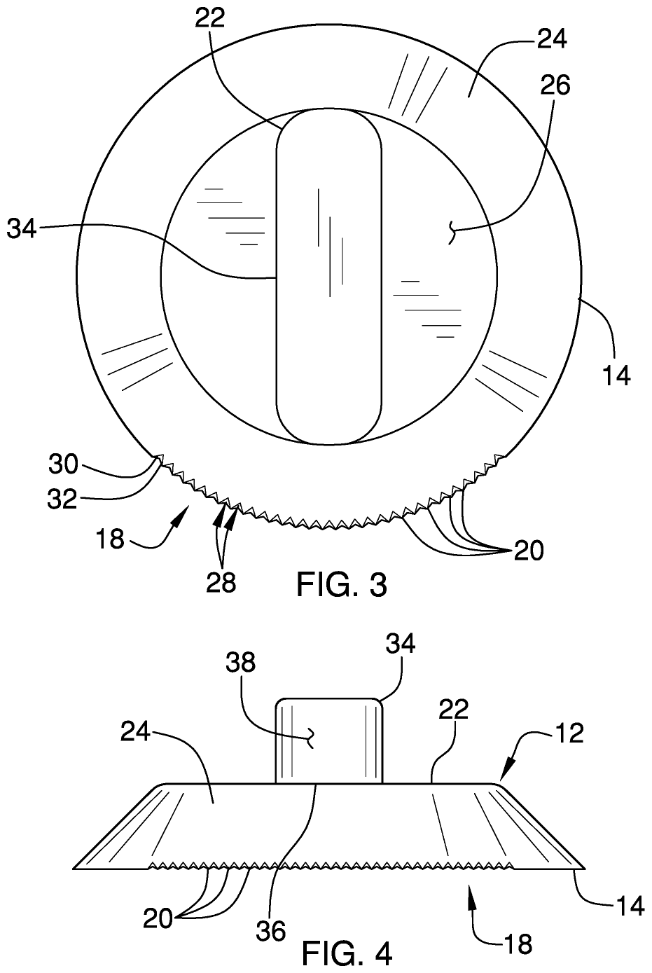

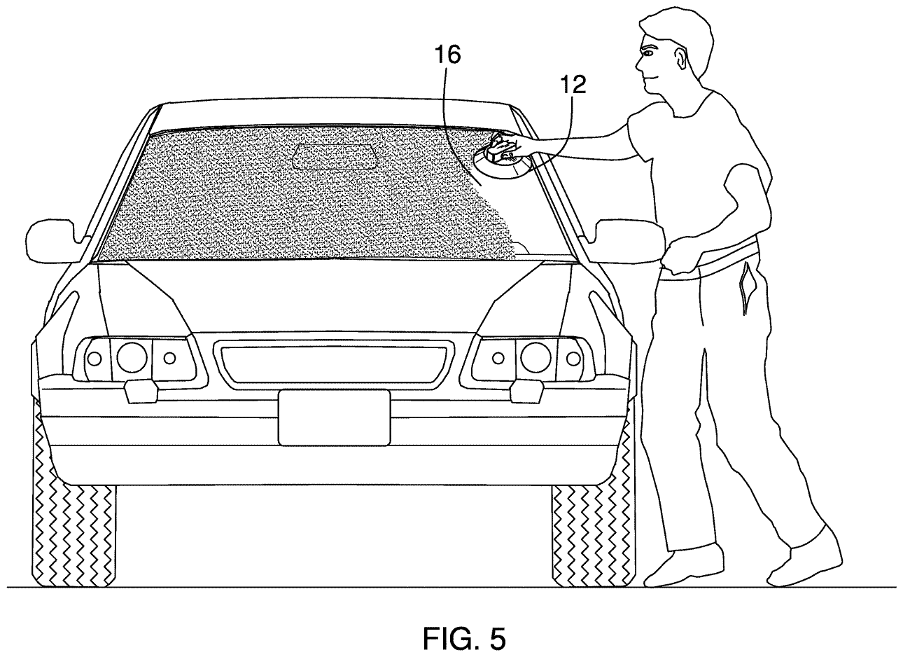

With reference now to the drawings, and in particular to FIGS. 1 through 5 thereof, a new scraping device embodying the principles and concepts of an embodiment of the disclosure and generally designated by the reference numeral 10 will be described.

As best illustrated in FIGS. 1 through 5, the ice scraping assembly 10 generally comprises a bowl 12 that has an outer edge 14, and the outer edge 14 tapers to a point. Thus, the outer edge 14 can abrade ice from a windshield 16 on a vehicle or the like. Moreover, the outer edge 14 has a jagged portion 18 comprising a plurality of teeth 20 to enhance abrading the ice from the windshield 16. The bowl 12 has a top wall 22 and an outer wall 24 extending away therefrom, and the top wall 22 has a perimeter edge 24 and a top surface 26. The outer wall 24 is coextensive with the perimeter edge 24 of the top wall 22 and the outer wall 24 includes the outer edge 14.

The outer wall 24 flares outwardly from the top wall 22 at an angle of approximately 45.0 degrees and the outer edge 14 is spaced from the top wall 22. The jagged portion 18 comprises a plurality of indentations 28 each extending toward the top wall 22. The indentations 28 are spaced apart from each other and are distributed along the outer edge 14 to define the plurality of teeth 20. Each of the indentations 28 has a first bounding surface 30 and a second bounding surface 32, and the first 30 and second 32 bounding surfaces of each of the indentations 28 are oriented at an angle with each other. Thus, each of the indentations 28 and the plurality of teeth 20 form a repeating sequence of triangles.

A grip 34 is coupled to the bowl 12 for gripping, and the grip 34 has a first surface 36 and an outer surface 36. The first surface 36 is coupled to the top surface 26 of the top wall 22 and the outer surface 36 of the grip 34 is gripped. The grip 34 may alternatively comprise a strap or any other type of grip 34 that can be engaged by a human hand.

In use, the grip 34 is gripped and the outer edge 14 of the outer wall 24 of the bowl 12 is positioned against the windshield 16. The bowl 12 is urged along the windshield 16 such that the outer edge 14 abrades ice from the windshield 16 during winter. Additionally, the jagged portion 18 of the outer edge 14 can be positioned against the windshield 16 to enhance abrading the ice from the windshield 16. The bowl 12 can be urged in a circular motion on the windshield 16 or in a straight line.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ice scraping assembly being configured to scrape ice from a windshield of a vehicle, said assembly comprising:
a bowl having an outer edge, said outer edge tapering to a point wherein said outer edge is configured to abrade ice from a windshield, said outer edge having a jagged portion comprising a plurality of teeth wherein said teeth are configured to enhance abrading the ice from the windshield; and
a grip being coupled to said bowl for gripping.

2. The assembly according to claim 1, wherein said bowl has a top wall and an outer wall extending away therefrom, said top wall having a perimeter edge and a top surface, said outer wall being coextensive with said perimeter edge of said top wall, said outer wall having said outer edge, said outer wall flaring outwardly from said top wall at an angle of approximately 45.0 degrees, said outer edge being spaced from said top wall.

3. The assembly according to claim 2, wherein said jagged portion comprises a plurality of indentations each extending toward said top wall, said indentations being spaced apart from each other and being distributed along said outer edge to define said plurality of teeth.

4. The assembly according to claim 3, wherein each of said indentations having a first bounding surface and a second bounding surface, said first and second bounding surfaces of each of said indentations being oriented at an angle with each other such that each of said indentations and said plurality of teeth form a repeating sequence of triangles.

5. The assembly according to claim 2, wherein said grip has a first surface and an outer surface, said first surface being coupled to said top surface of said top wall wherein said outer surface is configured to be gripped.

6. An ice scraping assembly being configured to scrape ice from a windshield of a vehicle, said assembly comprising:
a bowl having an outer edge, said outer edge tapering to a point wherein said outer edge is configured to abrade ice from a windshield, said outer edge having a jagged portion comprising a plurality of teeth wherein said teeth are configured to enhance abrading the ice from the windshield, said bowl having a top wall and an outer wall extending away therefrom, said top wall having a perimeter edge and a top surface, said outer wall being coextensive with said perimeter edge of said top wall, said outer wall having said outer edge, said outer wall flaring outwardly from said top wall at an angle of approximately 45.0 degrees, said outer edge being spaced from said top wall, said jagged portion comprising a plurality of indentations each extending toward said top wall, said indentations being spaced apart from each other and being distributed along said outer edge to define said plurality of teeth, each of said indentations having a first bounding surface and a second bounding surface, said first and second bounding surfaces of each of said indentations being oriented at an angle with each other such that each of said indentations and said plurality of teeth form a repeating sequence of triangles; and
a grip being coupled to said bowl for gripping, said grip having a first surface and an outer surface, said first surface being coupled to said top surface of said top wall wherein said outer surface is configured to be gripped.
